(19) United States
(12) Patent Application Publication
(10) Pub. No.: US 2014/0377166 A1
(43) Pub. Date: Dec. 25, 2014

(54) SYSTEMS AND METHODS FOR REMOVING FINELY DISPERSED PARTICULATE MATTER FROM A FLUID STREAM

(71) Applicant: Soane Mining, LLC, Cambridge, MA (US)

(72) Inventors: David S. Soane, Chestnut Hill, MA (US); Nathan Ashcraft, Somerville, MA (US); Manuel Esquivel, Cambridge, MA (US)

(21) Appl. No.: 14/312,164

(22) Filed: Jun. 23, 2014

Related U.S. Application Data
(60) Provisional application No. 61/838,599, filed on Jun. 24, 2013.

(51) Int. Cl. C02F 1/54; C02F 1/38; C01B 5/00; C02F 1/00

(52) U.S. Cl. CPC C02F 1/54; C02F 1/004; C02F 1/385; C01B 5/00; C02F 2103/10
USPC 423/580.1; 210/726; 210/199

(57) ABSTRACT

Disclosed are methods of removing particulate matter from a wastewater stream, comprising providing an activating agent capable of being affixed to the particulate matter in the wastewater stream; affixing the activating agent to the particulate matter to form activated particles residing in the wastewater stream; processing the activated particles in a thickener device to produce a population of thickened flocs in the fluid stream, wherein the thickened flocs comprise the particulate matter; contacting the thickened flocs with a re-activating agent to form re-activated particles comprising the particulate matter; providing a population of tether-bearing anchor particles, wherein the tether-bearing anchor particles have an affinity for the re-activated particles; attaching the tether-bearing anchor particles to the re-activated particles to form removable complexes that comprise the particulate matter, and removing the removable complexes, thereby removing the particulate matter from the wastewater stream.

### RELATED APPLICATION

This application claims the benefit of U.S. Provisional Application Ser. No. 61/838,599, filed Jun. 24, 2013. The entire contents of the above application are incorporated by reference herein.

### FIELD OF THE APPLICATION

The application relates generally to the use of particles for removing finely dispersed particulate matter from fluid streams.

### BACKGROUND

Fine materials generated from mining activities are often found well-dispersed in aqueous environments, such as wastewater. The finely dispersed materials may include such solids as various types of clay materials, recoverable materials, fine sand and silt. Separating these materials from the aqueous environment can be difficult, as they tend to retain significant amounts of water, even when separated out, unless special energy-intensive dewatering processes or long-term settling practices are employed.

A typical approach to consolidating fine materials dispersed in water involves the use of coagulants or flocculants. This technology works by linking together the dispersed particles by use of multivalent metal salts (such as calcium salts, aluminum compounds or the like) or high molecular weight polymers such as partially hydrolyzed polyacrylamides. With the use of these agents, there is an overall size increase in the suspended particle mass; moreover, their surface charges are neutralized, so that the particles are destabilized. The overall result is an accelerated sedimentation of the treated particles.

Technologies, such as those disclosed in U.S. Pat. Nos. 8,349,188 and 8,353,641, and U.S. Patent Application Publication No. US20130336877A1, have proven useful in enhancing the settlement rate of dispersed fine materials by incorporating them within a coarser particulate matrix, so that solids can be removed from aqueous suspension as a material having mechanical stability. These technologies are termed “ATA” (an acronym for anchor-tether-activator).

In certain settings however, existing infrastructure routes the tailings stream through a device known as a thickener. Flocculants are mixed with the tailings stream as this suspension enters the feedwell of the thickener tank. The flocculated fine particles then settle at the bottom of the tank, compacting into a dense slurry. The dense slurry material at the bottom of the thickener is raked into an underflow pipe, while the suspension fluid rises to the top for collection as a clear water stream. Underflow slurry densities can range from 35-50% solids by weight. This process yields an outflow (underflow) fluid stream comprising suspended solids with a significant amount of water that remains trapped with the sedimented particles. Since this technology does not release enough water from the sedimented material that the material becomes mechanically stable, further dewatering is typically necessary.

There remains a need in the art to improve the interaction of the ATA technology with the thickener infrastructure, so that tailings that are processed through this treatment system can yield a recovered or recoverable solid material that retains minimal water, so that it can readily be formed into a mechanically stable substance.

### SUMMARY

Disclosed herein, in embodiments, are methods of removing particulate matter from a wastewater stream, comprising: providing an activating agent capable of being affixed to the particulate matter in the wastewater stream; affixing the activating agent to the particulate matter to form activated particles residing in the wastewater stream; processing the activated particles in a thickener device to produce a population of thickened flocs in the fluid stream, wherein the thickened flocs comprise the particulate matter; contacting the thickened flocs with a re-activating agent to form re-activated particles comprising the particulate matter; providing a population of tether-bearing anchor particles, wherein the tether-bearing anchor particles have an affinity for the re-activated particles; attaching the tether-bearing anchor particles to the re-activated particles to form removable complexes that comprise the particulate matter, and removing the removable complexes, thereby removing the particulate matter from the wastewater stream. In embodiments, the particulate matter can comprise clay fines. The method can further comprise treating the particulate matter with a pre-activating agent before or simultaneously with the step of affixing the activating agent to the particulate matter. In embodiments, the activating agent is the same as the re-activating agent. In embodiments, the population of thickened flocs is removed from the thickener device before the step of contacting it with the re-activating agent. In embodiments, the removable complexes can be removed by filtration, centrifugation, or gravitational settling. In embodiments, the tether-bearing anchor particles can comprise sand, crushed rock, or sodium chloride. In embodiments, the tether-bearing anchor particles can comprise a material indigenous to the mining operation. In embodiments, the wastewater stream can comprise waste tailings fluid from a mining operation. Also disclosed herein are products obtained or obtainable by any of the foregoing methods.

Further disclosed herein, in embodiments, are systems for removing particulate matter from a wastewater fluid from a mining site, comprising: a conduit that transports the wastewater fluid containing particulate matter from the mining site; an activating agent affixable to the particulate matter in the wastewater fluid; a first introducer that directs the activating agent into contact with the particulate matter in the conduit to form activated particles; a thickener device in fluid communication with the conduit, wherein the thickener device treats the activated particles to form a thickened slurry; an outlet channel in fluid communication with the thickener device to remove the thickened slurry from the thickener device; a re-activating agent that interacts with the thickened slurry to form re-activated fines; a second introducer that directs the re-activating agent into contact with the thickened slurry; a population of tether-bearing anchor particles capable of attaching to the re-activated fines to form removable complexes in the outlet channel, wherein the removable complexes comprise the particulate matter; a mixer that directs the tether-bearing anchor particles into contact with the reactivated fines; and a separator for separating the removable complexes from the outlet channel, thereby removing the particulate matter from the wastewater fluid.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram illustrating wastewater treatment process using a thickener device.

FIG. 2 is a schematic diagram illustrating the anchor-tether-activator process.

FIG. 3 is a schematic diagram illustrating a process combining the anchor-tether-activator process with a wastewater treatment process using a thickener device.

FIG. 4 is a schematic diagram illustrating a wastewater treatment process using a thickener device with a re-activation step.

FIG. 5 is a schematic diagram illustrating a wastewater treatment process using a thickener device with a re-activation step.

FIG. 6 is a photograph of screened solids produced by treating a tailings sample (Sample A) with the anchor-tether-activator process.

FIG. 7 is a photograph of screened solids produced by treating a tailings sample (Sample B) with the anchor-tether-activator process.

FIG. 8 is a photograph of screened solids produced by treating a tailings sample (Sample C) with the anchor-tether-activator process.

FIG. 9 is a photograph of screened solids produced by treating a tailings sample (Sample A) with the anchor-tether-activator process following treatment in a thickener device.

FIG. 10 is a photograph of screened solids produced by treating a tailings sample (Sample B) with the anchor-tether-activator process following treatment in a thickener device.

FIG. 11 is a photograph of screened solids produced by treating a tailings sample (Sample C) with the anchor-tether-activator process following treatment in a thickener device.

FIG. 12 is a photograph of screened solids produced from tailings (Sample A) treated with a re-activation step.

FIG. 13 is a photograph of screened solids produced from tailings (Sample B) treated with a re-activation step.

FIG. 14 is a photograph of screened solids produced from tailings (Sample C) treated with a re-activation step.

### DETAILED DESCRIPTION

Disclosed herein are systems and methods for removing finely dispersed materials or “fines” from wastewater streams produced during mining operations. These systems and methods are particularly useful in combination with wastewater treatment facilities that utilize thickener devices. As described below in more detail, a thickener device is used as part of a system for separating fines from wastewater suspensions.

The terms “thickener” and “thickener device” refer to large settling tanks used, for example, to provide residence time for a slurry of suspended particles, for example, mining tailings, to settle out under gravity settling, while the clarified process fluid overflows the edge of the thickener and is collected in a circumferential overflow weir. Thickeners commonly have a slightly tapered, conical base. To enhance settling and compaction of the settled particles in the thickener, large, slowly-rotating “rakes” can gently mix the contents of the thickener tank and also serve to move the material to the discharge point at the center of the conical base. To enhance thickener performance, for example, to increase settling rates and separation, flocculants are frequently added to the slurry stream immediately prior to or in the feed well of a thickener. Flocculants can, for example, destabilize and aggregate fine particles in a slurry, causing them to aggregate and thus settle faster. Non-limiting examples of commercial flocculants are neutral and anionic polyacrylamides.

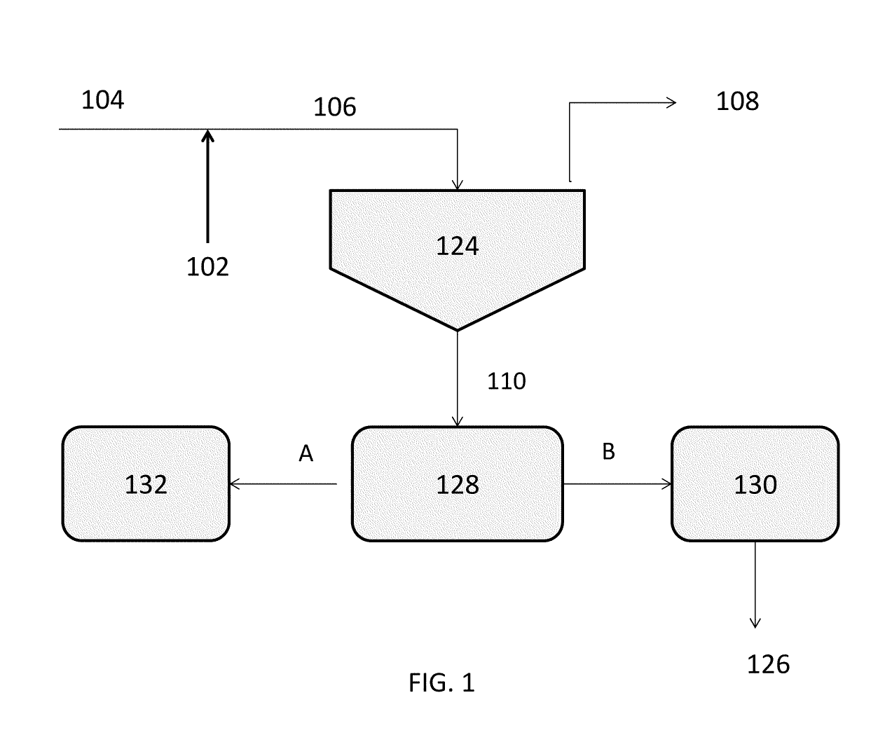

As illustrated in FIG. 1, a wastewater stream 104 bearing suspended fines can be treated with a flocculant 102, yielding a stream of flocculated fines 106. The flocculated fines 106 are then directed to a thickener device 124, where the flocculated fines settle to the bottom of the device 124, and are thus separated from the suspending water. The thickener device 124 allows the suspending water to rise to the top of the device, where it is removed as a separate fluid stream 108. The device 124 may include, for example, a peripheral weir that collects the overflow water and allows its removal as an aqueous stream 108 for further disposal or reuse. The flocculated solids settling to the bottom of the device become compacted into a dense slurry or “mud” which can then be raked into an underflow cone on the bottom of the device, from which it can be pumped out for collection. In FIG. 1, a collection vessel 128 is depicted, which can act as a receptacle for the slurry 110; instead of a receptacle 128, other mechanisms can be used to collect the slurry 110 and direct it to its ultimate disposition. As depicted in FIG. 1, the slurry 110 that is collected in the collection vessel 128 can follow Path A to a collection pond or other permanent storage depot 132. The slurry that is collected in the collection vessel can also follow Path B to a dewatering system 130 that allows the solids in the slurry to be separated from the water, yielding a dry, solid material 126. Alternatively, instead of a collection vessel 128, the thickener underflow can be pumped directly to a collection pond for settling, or it can be pumped onto an artificial beach to accelerate its separation.

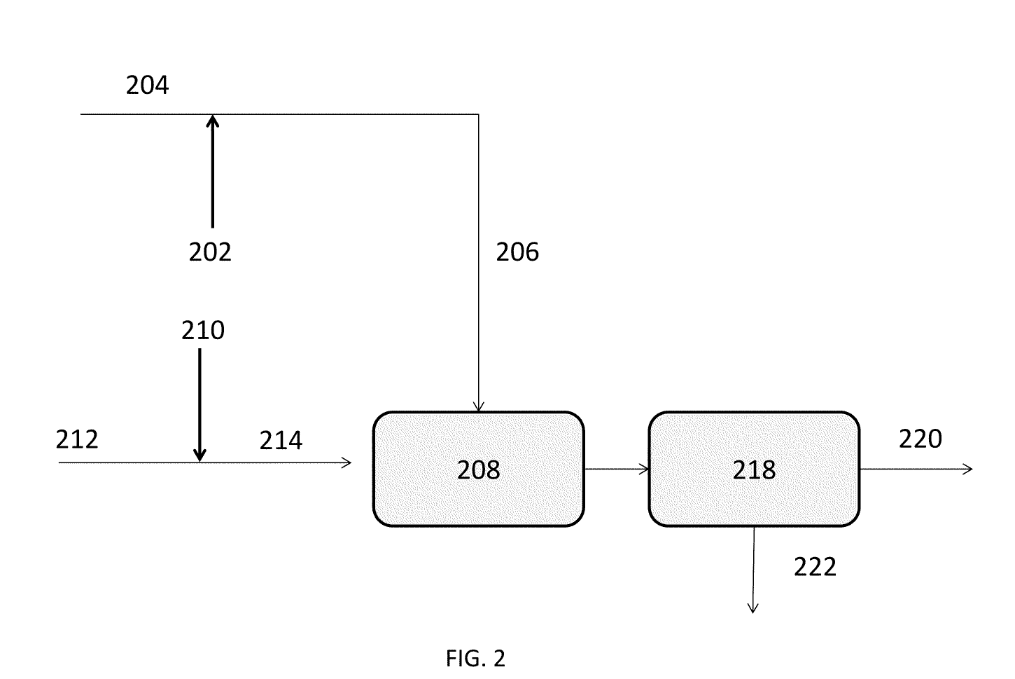

To improve the consolidation of the tailings solids, the ATA technology has been used in conjunction with thickener systems. The ATA technology and relevant modifications thereof have been previously described in U.S. Pat. Nos. 8,349,188 and 8,353,641, and U.S. Patent Application Publication No. 20130336877A1, the contents of each of which are incorporated herein by reference. The systems and methods disclosed in these patent references involve three components: activating the fine particles, tethering them to anchor particles, and sedimenting the fine particle-anchor particle complex. A schematic of these technologies, termed “ATA” (an acronym for anchor-tether-activator), is set forth in FIG. 2.

As shown in FIG. 2, an activation step as described in U.S. Pat. No. 8,349,188 can function as a pretreatment to prepare the surface of fine particles suspended in the tailings stream, so that the activated fine particles can interact with tether-bearing anchor particles. FIG. 2 depicts an activation step 202 where an activator polymer is introduced into a tailings stream 204 to form a population of activated fine particles 206. These activated fine particles can flow into a mixing unit 208, where they are combined with a stream carrying tether-bearing anchor particles. Tether-bearing anchor particles can be formed by combining an anchor particle, i.e., a particle that facilitates the separation of the fine particles, with a tethering material selected to have an affinity with the activator used to activate the fine particles, so that the interaction of the activator and the tether-bearing anchor particles forms complexes that can be readily separated from the fluid stream that suspends them. As shown in FIG. 2, a tethering material 210 is introduced into a stream 212 containing coarse material suitable for use as anchor particles. The tethering material 210 can be bound to the surface of the coarse material anchor particles, forming a stream 214 of tether-bearing anchor particles. This stream 214 enters the mixing unit 208, where the tether-bearing anchor particles complex with the activated fine particles. In a separator 218, the anchor-particle-fine complex can be separated as solid material 222, while the suspending fluid is released as clear water 220.

When used with conventional tailings, ATA produces a consolidated solid material that can be readily separated from aqueous suspension. ATA as applied to conventional tailings results in a faster settling process with easier separation of water from the consolidated solid; the recovered water is clear, and the solid material has superior mechanical properties. The ATA technology, when applied to tailings that have been processed through a thickener device, has not yielded similar results.

1. ATA and Thickener Devices

The ATA technology employs three subprocesses: (1) the “activation” of the wastewater stream bearing the fines by exposing it to a dose of a flocculating polymer that attaches to the fines; (2) the preparation of “anchor particles,” fine particles such as sand by treating them with a “tether” polymer that attaches to the anchor particles; and (3) adding the tether-bearing anchor particles to the activated wastewater stream containing the fines, so that the tether-bearing anchor particles form complexes with the activated fines. The activator polymer and the tether polymer have been selected so that they have a natural affinity with each other. Combining the activated fines with the tether-bearing anchor particles rapidly forms a solid complex that can be readily separated from the suspension fluid. Following the separation process, the solid complex forms a stable mass that can be used for beneficial purposes, as can the clarified water. As an example, the clarified water could be recycled for use on-site in further processing and beneficiation of ores. As an example, the stable mass could be used for construction purposes at the mine operation (roads, walls, etc.), or could be used as a construction or landfill material offsite. Dewatering to separate the solids from the suspension fluid can take place in seconds, relying only on gravity filtration.

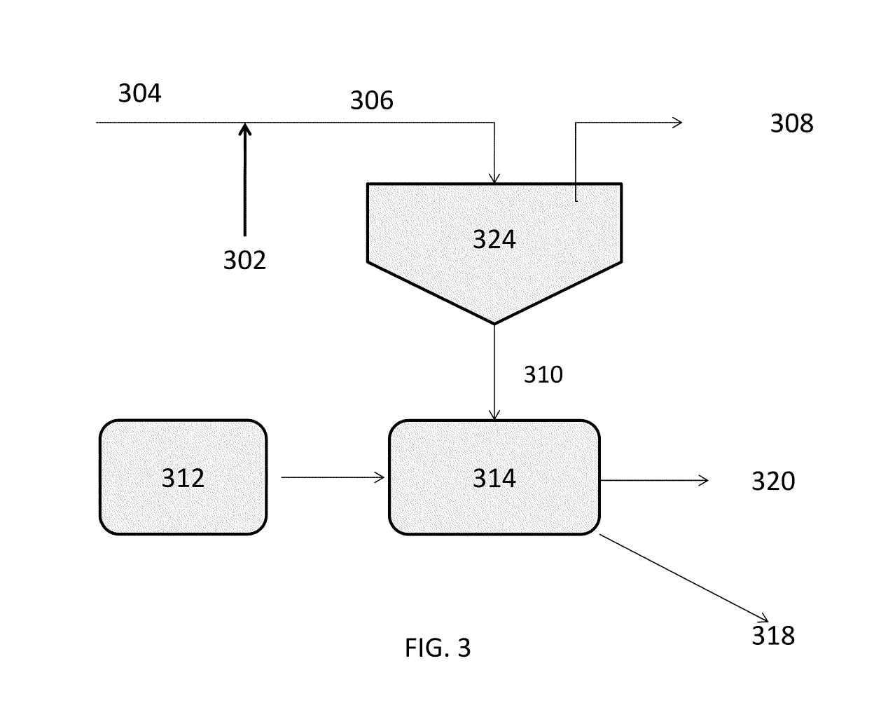

The initial combination of the ATA technology with the thickener device treatment system is shown schematically in FIG. 3. As depicted in FIG. 3, a wastewater stream 304 bearing suspended fines was treated with a flocculant or activating agent 302, yielding a stream of flocculated fines 306. The flocculated fines 306 were then directed to a thickener device 324, where the flocculated fines settled to the bottom of the device 324 and were thus separated from the suspending water as a dense slurry 310.

It was believed that the addition of tether-bearing anchor particles 312 to the slurry 310 would result in the complexation of the tether-bearing anchor particles to the flocculated fines, which complexes could then be separated in a separation system 314 to yield a consolidated solid material 318 that could be easily separated from the suspending water 320. However, this result was not obtained. Instead, and unexpectedly, the addition of the tether-bearing anchor particles did not result in further consolidation of the slurry (mud). Instead, the tether-bearing anchor particles remained segregated from the slurry (mud) and quickly settled to the bottom of the settling container. Not to be bound by theory, it is hypothesized that the mechanical agitation imparted by the thickener rakes and discharge pumps on the flocculated, settled fines disrupts and/or destroys the aggregate structure that was created by the addition of the activating agent, so that instead of the flocculated fines being able to complex with the tether-bearing anchor particles, this consolidation did not take place, allowing the tether-bearing anchor particles to settle out of the slurry without effecting further consolidation.

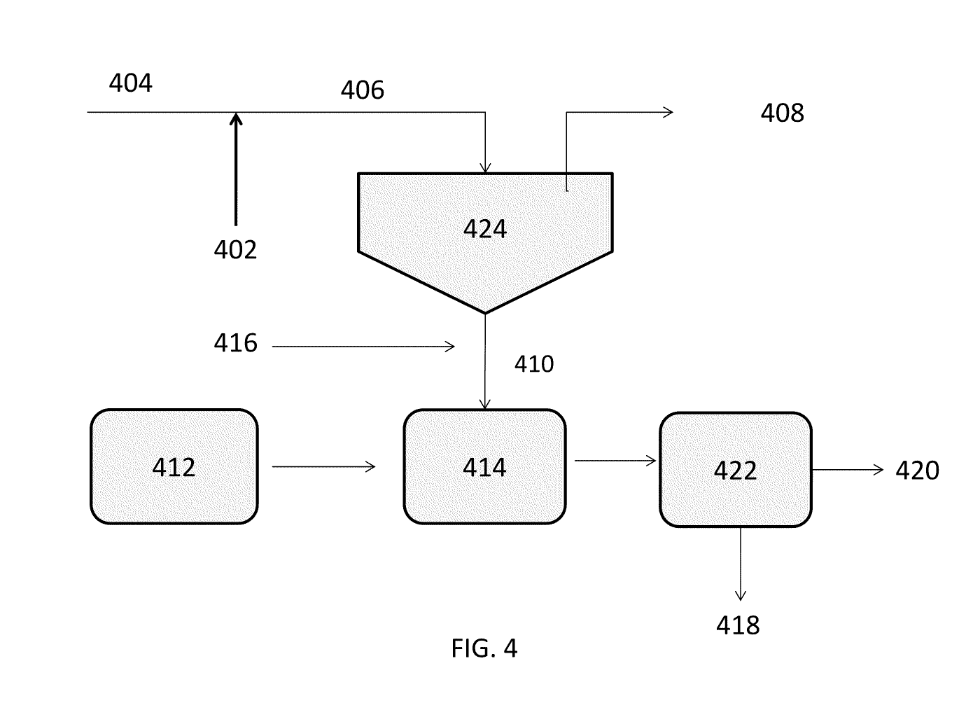

To overcome the action of the thickener device, a re-activation step was performed, as shown in FIG. 4. As depicted in FIG. 4, a wastewater stream 404 bearing suspended fines is treated with a flocculant or activating agent 402, yielding a stream of flocculated fines 406. The flocculated fines 406 can then be directed to a thickener device 424, where the flocculated fines settle to the bottom of the device 424 and are thus separated from the suspending water as a dense slurry 410. This slurry 410 can then be treated with a re-activating agent 416. This agent 416 can be the same as or different than the flocculating or activating agent 402 added initially to the wastewater stream 404. The re-activating agent 416 interacts with the slurry 410 to produce reactivated fines that are receptive to interaction with tether-bearing anchor particles 412. As shown in FIG. 4, tether-bearing anchor particles 412 can be combined with the reactivated fines at a mixing point 414. The mixing point 414 can be a separate device, or the mixer 414 can represent the point of combination of the tether-bearing anchor particles with the re-activated fines in a fluid stream. When the tether-bearing anchor particles contact the re-activated fines, a consolidated solid material is formed that can be separated easily from the suspending water. This separation can take place through a separating system 422 that can separate the solid material 418 from the suspending water 420.

In embodiments, particulate matter such as suspended fines can be removed from a wastewater stream by the following general method: providing an activating agent capable of being affixed to the particulate matter in the wastewater stream; affixing the activating agent to the particulate matter to form activated particles residing in the wastewater stream; processing the activated particles in a thickener device to produce a population of thickened flocs in the fluid stream, wherein the thickened flocs comprise the particulate matter; contacting the thickened flocs with a re-activating agent to form re-activated particles comprising the particulate matter; providing a population of tether-bearing anchor particles, wherein the tether-bearing anchor particles have an affinity for the re-activated particles; attaching the tether-bearing anchor particles to the re-activated particles to form solid removable complexes that comprise the particulate matter, and removing the removable complexes, thereby removing the particulate matter from the wastewater stream. Removing the removable complexes can involve separating the consolidated solid material from suspending water, through, for example, a separating system.

2. Activation and Reactivation

The particles that can be activated in the initial activation step are generally fine particles that are resistant to sedimentation. Examples of particles that can be treated in accordance with the invention include metals, sand, inorganic, or organic particles. The particles are generally fine particles, such as particles having a mass mean diameter of less than 15 microns or particle fraction that remains with the filtrate following a filtration with, for example, a 325 mesh filter. The particles to be removed in the processes described herein are also referred to as “fines.” Processed material that has been subjected to treatment in a thickener device and is subsequently treated with a re-activating agent can be termed “re-activated fines.”

The activation step or the re-activation step may be performed using flocculants or other polymeric substances. The various polymers described herein as activator polymers are also suitable for use as re-activators. A re-activator may be the same polymer as the one selected for the activation step, or it may be a different polymer. Conveniently, the same polymer can be used both for activation and re-activation.

Preferably, the polymers or flocculants used as activators or re-activators can be charged, including anionic or cationic polymers. In embodiments, anionic polymers can be used, including, for example, olefinic polymers, such as polymers made from polyacrylate, polymethacrylate, partially hydrolyzed polyacrylamide, and salts, esters and copolymers thereof, such as sodium acrylate/acrylamide copolymers, polyacrylic acid, polymethacrylic acid, sulfonated polymers, such as sulfonated polystyrene, and salts, esters and copolymers thereof, and the like. Suitable polycations include: polyvinylamines, polyallylamines, polydiallyldimethylammoniums (e.g., polydiallyldimethylammonium chloride, branched or linear polyethyleneimine, crosslinked amines (including epichlorohydrin/dimethylamine, and epichlorohydrin/alkylenediamines)), quaternary ammonium substituted polymers, such as (acrylamide/dimethylaminoethylacrylate methyl chloride quat) copolymers and trimethylammoniummethylene-substituted polystyrene, polyvinylamine, and the like. Nonionic polymers suitable for hydrogen bonding interactions can include polyethylene oxide, polypropylene oxide, polyhydroxyethylacrylate, polyhydroxyethylmethacrylate, and the like. In embodiments, a polymer such as polyethylene oxide can be used as an activator or re-activator with a cationic tethering material in accordance with the description of tethering materials below. In embodiments, activator or re-activator polymers with hydrophobic modifications can be used. Flocculants such as those sold under the trademark MAGNAFLOC® by Ciba Specialty Chemicals can be used. In some embodiments, the activator is an anionic polyacrylamide. In yet additional embodiments, the re-activator is an anionic polyacrylamide. In yet further embodiments, the activator is an anionic polyacrylamide and the re-activator is an anionic polyacrylamide.

In embodiments, activators or re-activators such as polymers or copolymers containing carboxylate, sulfonate, phosphonate, or hydroxamate groups can be used. These groups can be incorporated in the polymer as manufactured; alternatively they can be produced by neutralization of the corresponding acid groups, or generated by hydrolysis of a precursor such as an ester, amide, anhydride, or nitrile group. The neutralization or hydrolysis step could be done on site prior to the point of use, or it could occur in situ in the process stream.

The activated particle can also be an amine functionalized or modified particle. As used herein, the term “modified particle” can include any particle that has been modified by the attachment of one or more amine functional groups as described herein. The functional group on the surface of the particle can be from modification using a multifunctional coupling agent or a polymer. The multifunctional coupling agent can be an amino silane coupling agent as an example. These molecules can bond to a particle surface (e.g., metal oxide surface) and then present their amine group for interaction with the particulate matter. In the case of a polymer, the polymer on the surface of the particles can be covalently bound to the surface or interact with the surface of the particle and/or fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine. In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. They can also be precipitated onto the surface in the case of chitosan for example. Since chitosan is soluble in acidic aqueous conditions, it can be precipitated onto the surface of particles by suspending the particles in a chitosan solution and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle. The polymers and particles can complex via forming one or more ionic bonds, covalent bonds, hydrogen bonding and combinations thereof, for example. Ionic complexing is preferred.

3. Pre-Activation

In embodiments, the activation step can be combined with a pre-activation step, for example, as described in more detail in U.S. Patent Application Publication No. 20130336877A1, the contents of which are incorporated by reference herein. Pre-activation refers to a processing step in which one or more selected small molecules are added to the tailing solution in advance of activator addition or simultaneous with the activator addition. Pre-activation is a desirable step to improve the shear stability of the consolidated fines produced by the ATA process. Not to be bound by theory, it is understood that pre-activation agents can alter the surface of the fine particles in the tailings stream so that they are more receptive to interaction with activators as part of the ATA process. Pre-activation is particularly advantageous in treating tailings from potash mines, where the high brine level of the tailings stream impairs the shear stability of the consolidated masses produced by ATA without preactivation.

In embodiments the pre-activation of the fine particles in the tailings stream may be performed by addition of a small molecule species. As used herein, the term “pre-activation” refers to the interaction of a modifier such as a small molecule with the individual fine particles in a liquid medium, such as an aqueous solution. The small molecule modifier can act as the pre-activating agent to enhance the receptivity of the fines to the activating agent, so that the pre-activated/activated fines consolidate more thoroughly and rapidly with the tether-bearing anchor particles, and so that the consolidated agglomerates are more stable.

The pre-activation step can be performed as an initial treatment to prepare the surface of the fine particles for further interactions in the subsequent phases of the tailings treatment. It is desirable for a pre-activation agent to have slight solubility in the liquid medium (e.g., the aqueous tailings stream) but to not be highly soluble. For example, the pre-activation step can modify the surface of the fine particles to have less affinity for being in solution, so that they become more predisposed to agglomerate with one another. Not to be bound by theory, it is believed that when the pre-activator interacts with the fine particles, the particles become relatively more hydrophobic, which causes them to be less stable in aqueous solution. Additionally, the pre-activated particles may also have a greater affinity to agglomerate and pack together. This modified surface character can be advantageous for subsequent treatment with an activator polymer to enhance the aggregation process of the fine particles before they encounter the tether-bearing anchor particles, and to improve the sedimentation, consolidation and dewatering of the complexes formed between the preactivated/activated fines and the tether-bearing anchor particles.

As an example, a small alkyl molecule with a terminal charged functional group can serve as a pre-activating agent to interact with fines in the aqueous solution. In embodiments, the small molecules used for pre-activation can be charged, including anionic or cationic molecules. In embodiments, anionic molecules can be used, including, for example, fatty acids such as octanoic acid, decanoic acid, dodecanoic acid, tetradecanoic acid, stearic acid, and the like.

As used herein, the term “fatty acid” includes all acyclic aliphatic carboxylic acids having 6 or more carbon atoms, for example those having a chain of six to twenty-eight carbons, which may be saturated or unsaturated, branched or unbranched. Fatty acids may include those aliphatic monocarboxylic acids derived from or contained in esterified form in an animal or vegetable fat, oil or wax. As examples, stearic acid, tall oil acids, and the like may be used. In embodiments, one or more fatty acids can be selected as pre-activation agents, where the fatty acid is deposited on the surface of the fine particles for pre-activating them. In embodiments, fatty acid salts can be used as pre-activation agents, including, for example, sodium octanoate, sodium decanoate, sodium stearate, and the like. Nonionic pre-activating agents containing PEG or PPG groups can also be used.

In embodiments, cationic compounds can be used as pre-activating agents. Some examples are alkyl amines, including octylamine, decylamine, dodecylamine, undecylamine, N,N-Dimethylnonylamine, and the like. In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle.

In embodiments, a polyetheramine, such as the JEFFAMINE® compounds (exemplified below in Table 1), can be used as pre-activating agents. In some embodiments, the polyetheramine can, for example, have Formula I, II, or III shown below:

CH—[OCH₂CH(R)]ₓ—[OCH₂CH(CH₃)]_{γ}—NH₂, wherein R is hydrogen or methyl (Formula I);

NH₂CH(CH₃)CH₂—[OCH₂CH(CH₃)]ₓ—NH₂ (Formula II);

NH₂CH(CH₃)CH₂—[OCH(CH₃)CH2]ₓ-[OCH₂CH₂]_{γ}[OCH₂CH(CH₃)]ₓ—NH₂ (Formula III)

TABLE 1
JEFFAMINE ® compounds

Jeffamine D-2000 diamine Polyetheramine
Jeffamine D-400
Jeffamine M-2070
Jeffamine XTJ 548
Jeffamine XTJ-500 diamine (EO based) Polyetheramines ED-600
Jeffamine XTJ-501 diamine (EO based) Polyetheramine ED-900
Jeffamine XTJ-502 diamine (EO based) Polyetheramine ED-2003
Jeffamine XTJ-505 (M600)
Jeffamine XTJ-506 (M-1000)
Jeffamine XTJ-507 (M-2005)
Jeffamine XTJ-507 (M2005) monoamine polyetheramine
Jeffamine XTJ-509 (T-3000) triamine Polyetheramine
Jeffamine XTJ-542 (Diamine, M~1000, based on [poly(tetramethylene
ether glycol)]/PPG copolymer)
Jeffamine XTJ-559 (Diamine, M~1000, based on [poly(tetramethylene
ether glycol)]/PPG copolymer)
Jeffamine XTJ-576 (SD-2001) (D-2000 based but both ends are secondary
amine)
Jeffamine XTJ-585 (SD-401) (D-400 based but both ends are secondary
amine)

Exemplary polyetheramines of Formula (I) are Jeffamine XTJ-505 (M-600) polyetheramine, Jeffamine XTJ-506 (M−1000) polyetheramine, Jeffamine XTJ-507 (M−2005) polyetheramine and Jeffamine M-2070 polyetheramine. Exemplary polyetheramines of Formula (II) are Jeffamine D-230 polyetheramine, Jeffamine D-230, Jeffamine D-400 polyetheramine and Jeffamine D-2000 polyetheramine. Exemplary polyetheramines of Formula (III) are Jeffamine XTJ-510 (D-4000) polyetheramine, Jeffamine XTJ-500 (ED-600) polyetheramine, Jeffamine XTJ-501 (ED-900) polyetheramine and Jeffamine XTJ-502 (ED-2003) polyetheramine.

Jeffamine XTJ-509 (T-3000) has the chemical formula of Formula (IV):

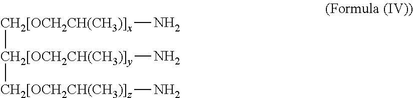

When pre-activation is used in combination with the other steps in tailings treatment, the method of treating tailings can employ four subprocesses: (1) the pre-activation of the wastewater stream bearing the fines by exposing it to a dose of small molecule pre-activator; (2) the activation of the wastewater stream bearing the fines by exposing it to a dose of an activator polymer that attaches to the pre-activated fines; (3) the preparation of tether-bearing anchor particles by coating or otherwise treating selected anchor particles with tether polymer; and (4) adding the tether-bearing anchor particles to the wastewater stream containing the pre-activated/activated fines, so that the tether-bearing anchor particles form complexes with the pre-activated/activated fines. In embodiments, the pre-activation agent is selected so that it interacts with the fine particles and enhances their ability to consolidate.

4. Tether-Bearing Anchor Particles

After the fines have been activated (with optional pre-activation), treated with the thickener device and re-activated, the re-activated fines can be complexed with tether-bearing anchor particles to form a dense complex readily separable from the fluid stream. As used herein, the term “tethering” refers to an interaction between a re-activated fine particle and an anchor particle (for example, as described below). The anchor particle can be treated or coated with a tethering material. The tethering material, such as a polymer, forms a complex or coating on the surface of the anchor particles such that the tethered anchor particles have an affinity for the activated fines. In embodiments, the selection of tether and re-activator materials is intended to make the two solids streams complementary so that the re-activated fine particles become tethered, linked or otherwise attached to the anchor particle. When attached to re-activated fine particles via tethering, the anchor particles enhance the rate and completeness of sedimentation or removal of the fine particles from the fluid stream.

In accordance with these systems and methods, the tethering material acts as a complexing agent to affix the activated particles to an anchor material. In embodiments, sand can be used as an anchor material, as may a number of other substances, as set forth in more detail below. In embodiments, a tethering material can be any type of material that interacts strongly with the activating material and that is connectable to an anchor particle.

As used herein, the term “anchor particle” refers to a particle that facilitates the separation of fine particles. Generally, anchor particles have a density that is greater than the liquid process stream. For example, anchor particles that have a density of greater than 1.3 g/cc can be used. Additionally or alternatively, the density of the anchor particles can be greater than the density of the fine particles or activated particles. Alternatively, the density is less than the dispersal medium, or density of the liquid or aqueous stream. Alternatively, the anchor particles are simply larger than the fine particles being removed. In embodiments, the anchor particles are chosen so that, after complexing with the fine particulate matter, the resulting complexes can be removed via a skimming process rather than a settling-out process, or they can be readily filtered out or otherwise skimmed off. In embodiments, the anchor particles can be chosen for their low packing density or potential for developing porosity. A difference in density or particle size can facilitate separating the solids from the medium.

For example, for the removal of particulate matter with an approximate mass mean diameter less than 50 microns, anchor particles may be selected having larger dimensions, e.g., a mass mean diameter of greater than 70 microns. An anchor particle for a given system can have a shape adapted for easier settling when compared to the target particulate matter: spherical particles, for example, may advantageously be used as anchor particles to remove particles with a flake or needle morphology. In other embodiments, increasing the density of the anchor particles may lead to more rapid settlement. Alternatively, less dense anchors may provide a means to float the fine particles, using a process to skim the surface for removal. In this embodiment, one may choose anchor particles having a density of less than about 0.9 g/cc, for example, 0.5 g/cc, to remove fine particles from an aqueous process stream.

Advantageously, anchor particles can be selected that are indigenous to a particular geographical region where the particulate removal process would take place. For example, sand or crushed rock can be used as the anchor particle for use in removing fine particulate matter from the waste stream (tailings) of mining operations. Or, for example, sodium chloride particles may be used, for example in potash mining.

Suitable anchor particles can be formed from organic or inorganic materials, or any mixture thereof. In referring to an anchor particle, it is understood that such a particle can be made from a single substance or can be made from a composite. For example, coal can be used as an anchor particle in combination with another organic or inorganic anchor particle. Any combination of inorganic or organic anchor particles can be used. Anchor particle combinations can be introduced as mixtures of heterogeneous materials. Anchor particles can be prepared as agglomerations of heterogeneous materials, or other physical combinations thereof.

In accordance with these systems and methods, inorganic anchor particles can include one or more materials such as sodium chloride, calcium carbonate, dolomite, calcium sulfate, kaolin, talc, titanium dioxide, sand, diatomaceous earth, aluminum hydroxide, silica, other metal oxides and the like. In embodiments, the coarse fraction of the solids recovered from the mining process itself can be used for anchor particles, for example, coal from coal mining. In certain embodiments, macroscopic particles in the millimeter range may be suitable. For example, the inorganic material used as an anchor particle can be derived from the mineral waste products of processing ores or processing coal. Other inorganic materials available on-site (sand, etc.) can be used as anchor particles, either alone or in combination with other inorganic or organic anchor particles. This technology has the advantage of using materials that are readily available on-site during mineral or coal processing to treat the fines being produced there.

In embodiments, the anchor particle can be substantially larger than the fine particulates it is separating out from the process stream. For example, for the removal of fines with approximate diameters less than 50 microns, anchor particles may be selected for modification having larger dimensions. In other embodiments, the particle can be substantially smaller than the particulate matter it is separating out of the process stream, with a number of such particles interacting in order to complex with the much larger particulate matter. Particles may also be selected for modification that have shapes adapted for easier settling when compared to the target particulate matter: spherical particles, for example, may advantageously be used to remove flake-type particulate matter. In other embodiments, dense particles may be selected for modification, so that they settle rapidly when complexed with the fine particulate matter in the process stream. In yet other embodiments, extremely buoyant particles may be selected for modification, so that they rise to the fluid surface after complexing with the fine particulate matter, allowing the complexes to be removed via a skimming process rather than a settling-out process. In embodiments where the modified particles are used to form a filter, as in a filter cake, the particles selected for modification can be chosen for their low packing density or porosity. Advantageously, particles can be selected that are indigenous to a particular geographical region where the particulate removal process would take place. For example, sand can be used as the particle to be modified for removing particulate matter from the waste stream (tailings) in phosphate mining or other mining activities. It is envisioned that the complexes formed from the modified particles and the particulate matter can be recovered and used for other applications. For example, when sand is used as the modified particle and it captures fine clay in tailings, the sand/clay combination can be used for road construction in the vicinity of the mining sites, due to the less compactable nature of the complexes compared to other locally available materials.

Anchor particle sizes (as measured as a mean diameter) can have a size up to few hundred microns, preferably greater than about 70 microns. In certain embodiments, macroscopic anchor particles up to and greater than about 1 mm may be suitable. Recycled materials or waste, particularly recycled materials and waste having a mechanical strength and durability suitable to produce a product useful in building roads and the like, or (in other embodiments) capable of combustion, are particularly advantageous.

Tethering materials are selected to have affinity with the agents used in the re-activation step. As an example of a tethering material used with an anchor particle in accordance with these systems and methods, chitosan can be precipitated onto sand particles, for example, via pH-switching behavior. The chitosan can have affinity for anionic systems that have been used to re-activate fine particles. Anchor particles can be complexed with tethering agents, such agents being selected so that they interact with the polymers used to activate the coal fines. In one example, partially hydrolyzed polyacrylamide polymers can be used to activate particles, resulting in a particle with anionic charge properties. The cationic charge of the chitosan will attract the anionic charge of the activated particles, to attach the sand particles to the activated fine particles.

In embodiments, various interactions such as electrostatic, hydrogen bonding or hydrophobic behavior can be used to affix a re-activated particle or particle complex to a tethering material complexed with an anchor particle. In embodiments, the anchor particles can be combined with a polycationic polymer, for example a polyamine.

One or more populations of anchor particles may be used, each being combined with a tethering agent selected for its attraction to the re-activated fines and/or to the other anchor particle's tether. The tethering functional group on the surface of the anchor particle can be from modification using a multifunctional coupling agent or a polymer. The multifunctional coupling agent can be an amino silane coupling agent as an example. These molecules can bond to an anchor particle's surface and then present their amine group for interaction with the re-activated fines. In the case of a tethering polymer, the polymer on the surface of the particles can be covalently bound to the surface or interact with the surface of the anchor particle using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine.

In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. They can also be precipitated onto the surface in the case of chitosan for example. Since chitosan is soluble in acidic aqueous conditions, it can be precipitated onto the surface of particles by suspending the particles in a chitosan solution and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle. The tethering polymers and anchor particles can complex via forming one or more ionic bonds, covalent bonds, hydrogen bonding and combinations thereof, for example. Ionic complexing is preferred.

As an example of a tethering material used with an anchor particle in accordance with these systems and methods, chitosan can be precipitated onto anchor particles, for example, via pH-switching behavior. The chitosan as a tether can have affinity for anionic systems that have been used to activate fine particles. In one example, partially hydrolyzed polyacrylamide polymers can be used to re-activate fines, resulting in a particle with anionic charge properties. The cationic charge of the chitosan will attract the anionic charge of the activated particles, to attach the anchor particles to the re-activated fines. In the foregoing example, electrostatic interactions can govern the assembly of the activated fine particle complexes bearing the anionic partially-hydrolyzed polyacrylamide polymer and the cationic anchor particles complexed with the chitosan tethering material.

In embodiments, polymers such as linear or branched polyethyleneimine can be used as tethering materials. It would be understood that other anionic or cationic polymers could be used as tethering agents, for example polydiallyldimethylammonium chloride (poly(DADMAC)). In other embodiments, cationic tethering agents such as epichlorohydrin dimethylamine (epi/DMA), styrene maleic anhydride imide (SMAI), polyethylene imide (PEI), polyvinylamine, polyallylamine, amine-aldehyde condensates, poly(dimethylaminoethyl acrylate methyl chloride quaternary) polymers and the like can be used. Advantageously, cationic polymers useful as tethering agents can include quaternary ammonium or phosphonium groups. Advantageously, polymers with quaternary ammonium groups such as poly(DADMAC) or epi/DMA can be used as tethering agents. In other embodiments, polyvalent metal salts (e.g., calcium, magnesium, aluminum, iron salts, and the like) can be used as tethering agents. In other embodiments cationic surfactants such as dimethyldialkyl(C8-C22)ammonium halides, alkyl(C8-C22)trimethylammonium halides, alkyl(C8-C22)dimethylbenzylammonium halides, cetyl pyridinium chloride, fatty amines, protonated or quaternized fatty amines, fatty amides and alkyl phosphonium compounds can be used as tethering agents. In embodiments, polymers having hydrophobic modifications can be used as tethering agents.

The efficacy of a tethering material, however, can depend on the re-activating material. A high affinity between the tethering material and the re-activating material can lead to a strong and/or rapid interaction there between. A suitable choice for tether material is one that can remain bound to the anchor surface, but can impart surface properties that are beneficial to a strong complex formation with the re-activator polymer. For example, a polyanionic re-activator can be matched with a polycationic tether material or a polycationic re-activator can be matched with a polyanionic tether material. In one embodiment, a poly(sodium acrylate-co-acrylamide) re-activator is matched with a chitosan tether material.

In additional embodiments, the re-activator is an anionic polyacrylamide and the tethering material is a cationic polymer, including, for example, such cationic polymers described herein. In hydrogen bonding terms, a hydrogen bond donor should be used in conjunction with a hydrogen bond acceptor. In embodiments, the tether material can be complementary to the chosen re-activator, and both materials can possess a strong affinity to their respective deposition surfaces while retaining this surface property. In other embodiments, cationic-anionic interactions can be arranged between re-activated fines and tether-bearing anchor particles. The re-activator may be a cationic or an anionic material, as long as it has an affinity for the fine particles to which it attaches. The complementary (for example, having an opposite charge as that of the re-activator) tethering material can be selected to have affinity for the specific anchor particles being used in the system. In other embodiments, hydrophobic interactions can be employed in the re-activation-tethering system. In embodiments, various interactions such as electrostatic, hydrogen bonding or hydrophobic behavior can be used to affix a re-activated particle or particle complex to a tethering material complexed with an anchor particle. For example, electrostatic interactions can govern the assembly of the re-activated fine particle complexes bearing the anionic partially-hydrolyzed polyacrylamide polymer and sand particles complexed with the cationic chitosan tethering material. In embodiments, polymers such as linear or branched polyethyleneimine can be used as tethering materials. It would be understood that other anionic or cationic polymers could be used as tethering agents, for example polydiallyldimethylammonium chloride.

A tether-bearing anchor particle can be added to a reactivated stream in an amount that permits a flowable slurry. For example, the particle material can be added in an amount greater than 1 gram/liter but less than the amount which results in a non-flowable sludge, amounts between about 1 to about 10 grams/liter, preferably 2 to 6 g/l are often suitable. In some embodiments, it may be desirable to maintain the concentration of the anchor particles to 20 g/l or higher. The anchor particles may be fresh (unused) material, recycled, cleaned ballast, or recycled, uncleaned ballast. In embodiments, for example when sand is chosen as an anchor particle, higher amounts of the particle material may be added. For example, sand can be added in a range between 1-300 gm/l, preferably between 50-300 gm/l, for example at a dosage level of 240 gm/l.

It is envisioned that complexes formed from the anchor particles tethered to the re-activated particulate matter can be recovered and used for other applications. For example, when sand is used as the anchor particle and it captures fine clay in tailings, the dewatered sand/clay combination can be used for road construction in the vicinity of the mining sites, due to the less compactable nature of the complexes compared to other locally available materials. As another example, a sand/clay complex could be used to fill in strip mining pits, such as would be found at phosphate mining operations. In other embodiments, complexes with anchor particles and fines could be used in a similar manner on-site to fill in abandoned mines, or the complexes could be used offsite for landfill or construction purposes. The uses of the solid material produced by the systems and methods disclosed herein will vary depending on the specific constituents of the material. In embodiments, the interactions between the re-activated fine particles and the tether-bearing anchor particles can enhance the mechanical properties of the complex that they form. For example, a re-activated fine particle or collection thereof can be durably bound to one or more tether-bearing anchor particles, so that they do not segregate or move from the position that they take on the particles. This property of the complex can make it mechanically more stable. Increased compatibility of the re-activated fine materials with a denser (anchor) matrix modified with the appropriate tether polymer can lead to further mechanical stability of the resulting composite material. This becomes quite important when dealing with tailings resulting from mining. This composite material can then be further utilized within the project for road building, dyke construction, or even land reclamation, rather than simply left in a pond to settle at a much slower rate.

A variety of techniques are available for removing the activated-tethered-anchored (ATA) complexes from the fluid stream. For example, the tether-bearing anchor particles can be mixed into a stream carrying re-activated fine particles, and the complexes can then be separated via a settling process such as gravity or centrifugation. In another method, the process stream carrying the re-activated fine particles could flow through a bed or filter cake of the tether-bearing anchor particles. In any of these methods, the modified (anchor) particles interact with the re-activated particulates and pull them out of suspension so that later separation removes both modified particles and fine particulates.

As would be appreciated by artisans of ordinary skill, a variety of separation processes could be used to remove the complexes of modified particles and fine particulates. In the aforesaid removal processes, mechanical interventions for separating the ATA complexes can be introduced, employing various devices as separators (filters, skimmers, centrifuges, and the like), or other separation techniques can be employed. For example, if the anchor particles had magnetic properties, the complexes formed by the interaction of tether-bearing anchor particles and activated fine particulates could be separated using a magnetic field. As another example, if the tether-bearing anchor particles were prepared so that they were electrically conductive, the complexes formed by the interaction of tether-bearing anchor particles and activated fine particulates could be separated using an electric field. As would be further appreciated by those of ordinary skill, tether-bearing anchor particles could be designed to complex with a specific type of activated particulate matter. The systems and methods disclosed herein could be used for complexing with organic waste particles, for example. Other re-activation-tethering-anchoring systems may be envisioned for removal of suspended particulate matter in fluid streams, including gaseous streams.

5. Treatment of Mining Tailings

As described previously, and as illustrated in FIG. 4, the systems and methods disclosed herein can be applied to treatment of fine particles that are discharged into wastewater after mining operations. Extraction of minerals from ores can produce fine, positively charged particles of clay or other materials that remain suspended in the effluent fluid stream. In embodiments, the systems and methods disclosed herein can be applied to a variety of tailings treatments operations where the tailings stream is subjected to treatment by a thickener device.

As depicted in FIG. 4, a wastewater stream 404 bearing suspended fines is treated with a flocculant or activating agent 402, yielding a stream of flocculated fines 406. The flocculated fines 406 can then be directed to a thickener device 424, where the flocculated fines settle to the bottom of the device 424 and are thus separated from the suspending water as a dense slurry 410. This slurry 410 can then be treated with a re-activating agent 416. This agent 416 can be the same as or different than the flocculating or activating agent 402 added initially to the wastewater stream 404. The re-activating agent 416 interacts with the slurry 410 to produce re-activated fines that are receptive to interaction with tether-bearing anchor particles 412. As shown in FIG. 4, tether-bearing anchor particles 412 can be combined with the re-activated fines at a mixing point 414. The mixing point 414 can be a separate device, or the mixer 414 can represent the point of combination of the tether-bearing anchor particles with the re-activated fines in a fluid stream. When the tether-bearing anchor particles contact the re-activated fines, a consolidated solid material is formed that can be separated easily from the suspending water. This separation can take place through a separating system 422 that can separate the solid material 418 from the suspending water 420.

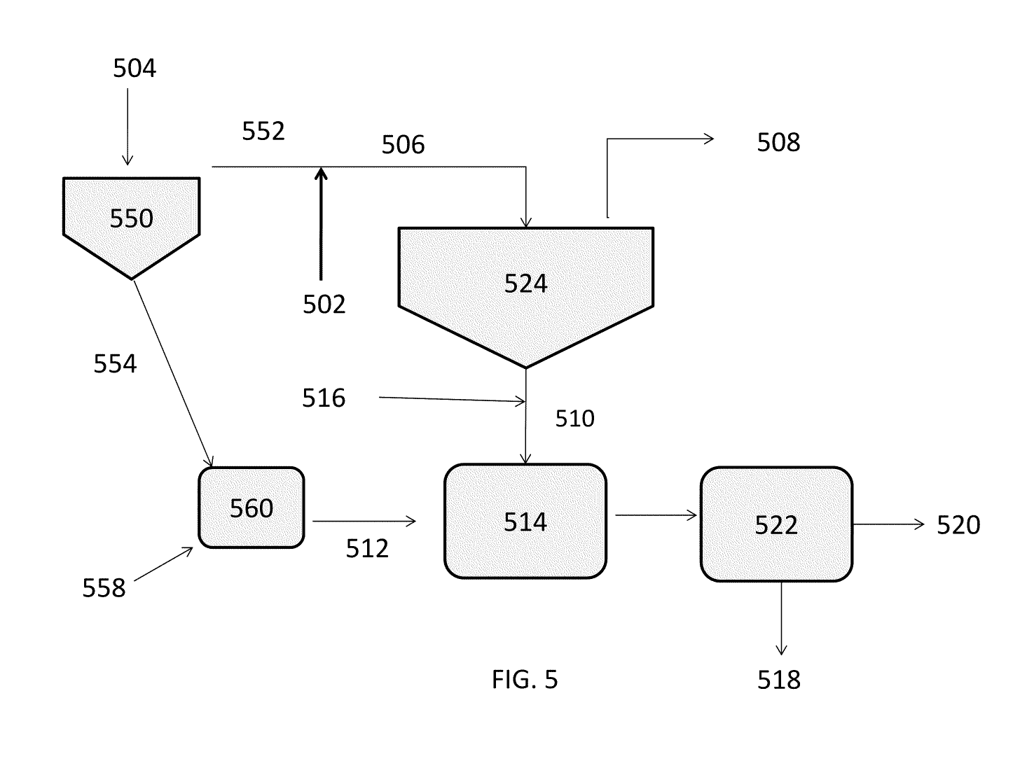

FIG. 5 depicts an embodiment of such a process. As shown in FIG. 5, an effluent fluid stream of mining wastewater 504 can be directed to a mechanical separator 550 such as a cyclone that can separate the fluid stream into two components, an overflow fluid 552 comprising fine tails that contains the fine (<approximately 50 micron) particles, and an underflow fluid stream 554 that contains coarse tails, mainly sand, with a small amount of fine clay particles. Each fluid stream can then be treated separately. An activating or flocculating agent 502, such as a polyanion as described above, can be introduced into the overflow fluid stream 552, resulting in a fluid stream of flocculated fine particles 506. This stream 506 can then be directed to the thickener device 524 with some separation of the solids component of the flocculated stream from the suspending water, with each component being removable from the thickening device as a separate fluid stream. In FIG. 5, the flocculated fines are shown as settling to the bottom of the device, from whence they are removed as a separate slurry 510. The supernatant water 508 is also removed. The slurry 510 can then be treated with a re-activating agent 516.

Concomitantly, the underflow fluid 554 comprising coarse tails (mainly sand) can be directed to a first mixing point 560 where they are admixed with a tethering agent as described above to form tether-bearing anchor particles 512. The mixing point 560 may be a separate vessel, a vessel in fluid communication with the rest of the system, or simply a point in a fluid stream where the particles of the underflow fluid 554 are contacted by the tethering agent in sufficient quantity to form the tether-bearing anchor particles 512. In certain underflow fluids 554, the sand within the underflow fluid itself can act as an “anchor particle,” as described above. A cationic tethering agent, as described above, can be introduced into the underflow fluid so that it self-assembles onto the surface of the anchor particles, creating a plurality of tether-bearing anchor particles 512.

Following this treatment to each fluid stream, they are recombined at a second mixing point 514 in a batch, semi-batch or continuous fashion. The tether-bearing anchor particles 512 can interact, preferably electrostatically, with the re-activated fine particles, forming large agglomerations of solid material that can be readily removed from or settled in the resulting fluid mixture through a separation process 522 that separates the solid material 518 from the suspending water 520.

In embodiments, the general principles set forth in FIG. 5 are amenable to deployment within existing tailings separation systems. In embodiments, a system for removing particulate matter from a wastewater fluid from a mining site can comprise in general: a conduit that transports the wastewater fluid containing particulate matter from the mining site; an activating agent affixable to the particulate matter in the wastewater fluid; a first introducer that directs the activating agent into contact with the particulate matter in the conduit to form activated particles; a thickening device in fluid communication with the conduit, wherein the thickening device treats the activated particles to form a thickened slurry; an outlet channel in fluid communication with the thickening device to remove the thickened slurry from the thickening device; a re-activating agent that interacts with the thickened slurry to form re-activated fines; a second introducer that directs the re-activating agent into contact with the thickened slurry; a population of tether-bearing anchor particles capable of attaching to the re-activated fines to form removable complexes in the outlet channel, wherein the removable complexes comprise the particulate matter; a mixer that directs the tether-bearing anchor particles into contact with the reactivated fines; and a separator for separating the removable complexes from the outlet channel, thereby removing the particulate matter from the wastewater fluid. The conduit containing the wastewater fluid suspending the particulate matter can carry overflow fluid produced by the mechanical separator that initially treats the tailings. The first introducer that directs the activating agent into contact with the particulate matter can be any sort of device that permits the introduction of the activating agent into a fluid stream, for example an injector or an in-line inflow circuit. The thickener device can mechanically agitate the activated particles to produce the thickened slurry, which separates from the suspending water to fall by gravity to the bottom of the thickener device. At the bottom of the thickener, an outlet channel carries the thickened slurry away from the thickener device. An injector or an in-line circuit can introduce the re-activating agent into the thickened slurry. Following the re-activation, the re-activated fines are contacted by the tether-bearing anchor particles. The tether-bearing anchor particles are mixed in with the re-activated fines at a mixing point, optionally with the use of mixing equipment to facilitate thorough mixing of the stream containing the re-activated fines with the anchor particles.

In embodiments, a treatment process can be added in-line to each of the separate flows. For example, removal of the agglomerations during the separation process can take place, for example, by filtration, centrifugation, or other type of mechanical separation. In an embodiment, the fluid path containing the agglomerated solids can be subsequently treated by a conveyor belt system, analogous to those systems used in the papermaking industry. In an exemplary conveyor belt system, the mixture of fluids and agglomerated solids resulting from the electrostatic interactions described above can enter the system via a headbox. A moving belt containing a mechanical separator can move through the headbox, or the contents of the headbox are dispensed onto the moving belt, so that the wet agglomerates are dispersed along the moving belt. One type of mechanical separator can be a filter with a pore size smaller than the average size of the agglomerated particles. The size of the agglomerated particles can vary, depending upon the size of the constituent anchor particles (i.e., sand). For example, for systems where the sand component has a size between 50/70 mesh, an 80 mesh filter can be used. Other adaptations can be envisioned by artisans having ordinary skill in the art. Agglomerated particles can be transported on the moving belt and further dewatered. Water removed from the agglomerated particles and residual water from the headbox from which agglomerates have been removed can be collected in whole or in part within the system and optionally recycled for use in subsequent processing. In embodiments, the filtration mechanism can be an integral part of the moving belt. In such embodiments, the captured agglomerates can be physically removed from the moving belt so that the filter can be cleaned and regenerated for further activity. In other embodiments, the filtration mechanism can be removable from the moving belt. In such embodiments, the spent filter can be removed from the belt and a new filter can be applied. In such embodiments, the spent filter can optionally serve as a container for the agglomerated particles that have been removed. Advantageously, as the agglomerated particles are arrayed along the moving belt, they can be dewatered and/or dried. These processes can be performed, for example, using heat, air currents, or vacuums. Agglomerates that have been dewatered and dried can be formed as solid masses, suitable for landfill, construction purposes, or the like. Desirably, the in-line tailings processing described above is optimized to capitalize upon the robustness and efficiency of the electrostatic interaction between the re-activated tailings and the tether-bearing anchor particles. Advantageously, the water is quickly removed from the fresh tailings during the in-line tailings processing, permitting its convenient recycling into the processing systems.

A number of mining operations yield wastewater streams containing fine particles produced during the processing or beneficiation of ores. As an example, the production of aluminum from bauxite ore according to the commonly-used Bayer process takes place by treating the crushed or ground ore with a hot sodium hydroxide solution to produce alumina (Al₂O₃), which can be reduced to yield aluminum. The insoluble part of the bauxite ore is carried away as an alkaline aqueous slurry called “red mud.” Red mud is a complex material with characteristics that depend on the bauxite from which it is derived, and on the process parameters that produce it. Common characteristics of red mud include a water suspension of fine particles suspended in a highly alkaline water solution, mainly composed of iron oxides, but having a variety of elements and mineralogical phases. The red mud fluid stream, containing about 7-9% solids, is typically sequestered in a containment area (an old excavated mine or a manmade lake called a tailings pond) so that the solids can settle out by gravity. About two tons of red mud is produced per ton of metallic aluminum. The magnitude of red mud associated with aluminum production poses a significant environmental challenge for countries where bauxite is refined. A small country like Jamaica, for example, where bauxite refinement is a leading industry, lacks open land suitable for disposal of the hazardous red mud; moreover, containment problems such as leakage, groundwater seepage and rupture of tailings pond dikes makes disposal of this material even more hazardous.

As another example, iron is produced from an ore called taconite that contains magnetite, an amalgam of iron oxides with about 25-30% iron. To extract the iron from the ore, the ore is crushed into fine particles so that the iron can be removed from the non-ferromagnetic material in the ore by a magnetic separator. The iron recovered by the magnetic separator is then processed into “pellets” containing about 65% iron that can be used for industrial purposes like steel-making. Ore material not picked up by the magnetic separator is considered waste material, or gangue, and is discarded. Gangue typically includes non-ferrous rocks, low-grade ore, waste material, sand, rock and other impurities that surround the iron in the ore. For every ton of pellets produced, about 2.7 tons of gangue is also produced. The waste is removed from the beneficiation site as a slurry of suspended fine particles, termed tailings. About ⅔ of the tailings are classified as “fine tailings,” composed of extremely fine rock particles 15 more than 90% of which are smaller than 75 microns, or −200 mesh); typically, the fine tailings they have little practical use at the mines, and end up sequestered in containment areas such as tailings ponds.

Another mining operation with similar wastewater handling issues is the production of kaolin. Kaolin (“china clay”) is a white claylike material composed mainly of a hydrated aluminum silicate admixed with other clay minerals. Kaolin, used for a variety of industrial applications, is mined and then processed; dry processes and wet processes are available. Wet processes, used extensively to produce additives for the paper industry, yield a slurry that is fractionated into coarse and fine fractions using a variety of mechanical means like centrifuges, hydrocyclones and hydroseparators. Despite repeated processing, a fraction of the slurry contains fine particulate kaolin that cannot be separated from other fine particulate waste residues. This material is deemed waste, and is sequestered in containment areas, either manmade lagoons or spent kaolin mines.

Trona (trisodium hydrogendicarbonate dihydrate) is a mineral that is mined in the United States as a source of sodium carbonate. After the trona is mined, it is processed by exposing it to aqueous solvents so that the sodium carbonate can be recovered. The insoluble materials in the trona, including oil shales, mudstone and claystone, is carried away as tailings for disposal. Tailings, containing suspended fine particles in a fluid stream, may be transported to confinement areas, like tailings ponds; alternatively, tailings may be pumped into abandoned areas of the mine, with retaining walls or other barriers being constructed as needed to prevent the tailings from entering mine areas that are still active.

Phosphatic ore (fluorapatite) mining is a major worldwide industry, with over 150 million tons of ore mined annually. Domestic mining produces around 30 million 10 tons of ore, about 75% of which comes from Florida. During the extraction of phosphate from the mined ore, a process called beneficiation, significant quantities of waste clay and sand are generated. The approximate ratio of the extracted ore is 1:1:1 of fluorapatite to clay to sand. Thus, with the 30 million tons of ore being mined, around 10 million tons of waste clay and 10 million tons of waste sand must be disposed of annually in the U.S. The clay that is produced by beneficiation exists in a 3-5% (by weight) slurry. The current practice of clay disposal is to store the clay slurry in large ponds known as clay settling areas (CSAs), where the clay is allowed to separate from the water suspension by gravity over long periods of time, i.e., several decades. For a typical phosphate mine, up to 60% of the surface area of the mine ends up as CSAs. Estimates are that around 5,000 acres of land is turned into CSAs annually in central Florida. Left untreated it can take several decades before CSAs become stable enough for reuse to be considered. Because of the huge environmental and economic impacts of CSAs, a simple, robust, and cost-effective method for treating the clay slurry waste is needed. While other methods for separating clay fines from wastewater slurries have been tried for phosphate mining, they have proven to be difficult and costly. For example, the Dewatering Instantaneously with Pulp Recycle (DIPR) process has been under investigation for over 20 years at the Florida Institute of Phosphate Research (FIPR), disclosed in U.S. Pat. No. 5,449,464. According to this disclosure, clay slurry is treated with a flocculant and a pulp material to dewater the slurry. While this approach has been studied for over two decades, its high cost, partly due to capital costs of equipment to dewater the treated slurry to high solids content, has prevented its adoption. There remains a need in the art, therefore, for an effective and economical approach to treating the clay-bearing wastewater slurry that is produced during phosphate beneficiation.

As another example, potash mining operations result in wastewater handling issues that can be advantageously addressed with the systems and methods disclosed herein. Potash is the general name for potassium salts, including potassium carbonate, and is mined for agricultural (fertilizer) use. A large portion of the mined potash ore ends up as a waste, either as a solid or slurry, called potash tailings. The potash tailings slurry is an aqueous saturated salt/brine stream that contains waste ore, clays, and other fine materials. The most common method for disposal is to pump the potash tailings into above-ground impoundment areas or mined underground pits. The large volumes of tailings and high salinity pose significant disposal issues. Additionally, large amounts of salt simply end up in these waste streams. Environmental concerns are adding increased pressure for potash mining companies to find alternatives to tailings ponds as a disposal practice.

A number of other mining operations produce fine particulate waste carried in fluid streams. Such fluid streams are suitable for treatment by the systems and methods disclosed herein. Modification of the fluid stream before, during or after application of these systems and methods may be advantageous. For example, pH of the fluid stream can be adjusted. Examples of additional mineral mining operations that have a waste slurry stream of fine particulate matter can include the following mining processes: sand and gravel, nepheline syenite, feldspar, ball clay, kaolin, olivine, dolomite, calcium-carbonate containing minerals, bentonite clay, magnetite and other iron ores, barite, and talc.

### EXAMPLES

The following materials were used in the Examples below:
Poly(diallyldimethylammonium chloride) (poly(DADMAC)) (20% w/v), Sigma Aldrich, St. Louis, Mo.
Flopam AN 934 VHM, SNF Inc., Riceboro, Ga.
Flopam AN 910 VHM, SNF Inc., Riceboro, Ga.
Fine and coarse tailings from three different operating US mines.

### Example 1

### Polymers Used

Solutions of the polymers shown in Table 2 were prepared and kept at room temperature. All solutions were prepared at 0.1 wt % concentration using tap water. These polymer solutions were screened for use in consolidating tailings. Polymer solutions were used as activator polymers, re-activator polymers, or as tether polymers (as applicable) to be attached to fines and anchor particles, as described in more detail below. When a polymer was used as a tether polymer, it was used in combination with a separate activator or re-activator polymer. For anchor particles to be used with tether polymers, coarse waste particles from U.S. mining operations were used. In experiments using anchor particles with tethers, the ratio of anchor particles to fines in the tailings was 0.5 for Samples A and C and 1.0 for Sample B on a mass basis.

TABLE 2
Polymers screened for treatment of tailings.

| | | | Molecular Weight |
|---|---|---|---|
| Polymer | Manufacturer | Charge | (g/mol) |
| poly(DADMAC) | Sigma Aldrich | Cationic | 400,000-500,000 |
| Flopam AN 934 VHM | SNF Inc. | Anionic | Very high |
| Flopam AN 910 VHM | SNF Inc. | Anionic | Very high |

### Example 2

### Tailings Samples

Tailings samples from operating mines were used. The composition of the tailings samples were approximately:
Sample A (silica tailings): 2.5 wt % clays, 97.5 wt % water
Sample B (phosphate tailings): 2.5 wt % clays, 97.5 wt % water
Sample C (phosphate tailings): 5.0 wt % clays, 95.0 wt % water.

Anchor particles were comprised of coarse sand that existed at 77.7% solids content for Sample A and 98.0% solids content for Samples B and C. All dosages are listed on a dry solids basis with respect to the fines in the tailings stream.

### Example 3

### Standard Tailings Treatment with Activator and Tether Polymers

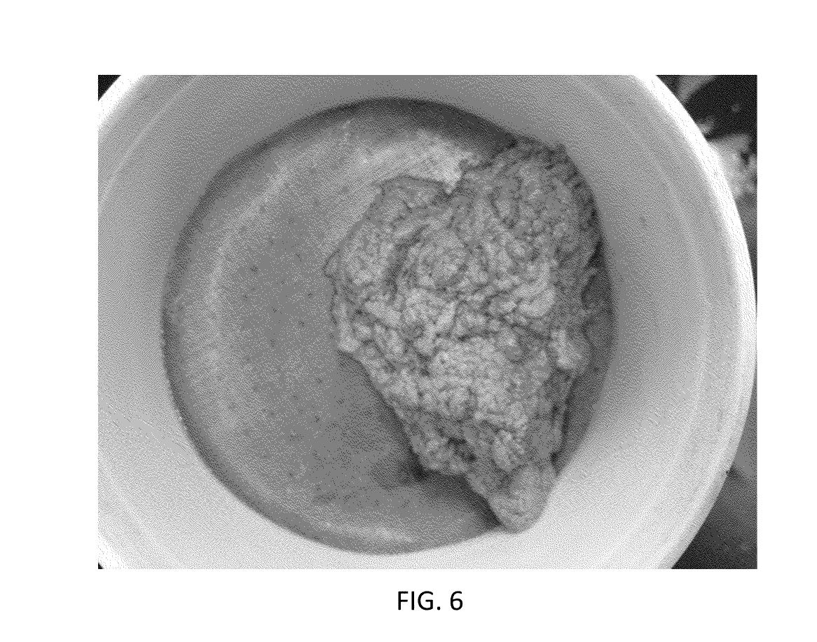

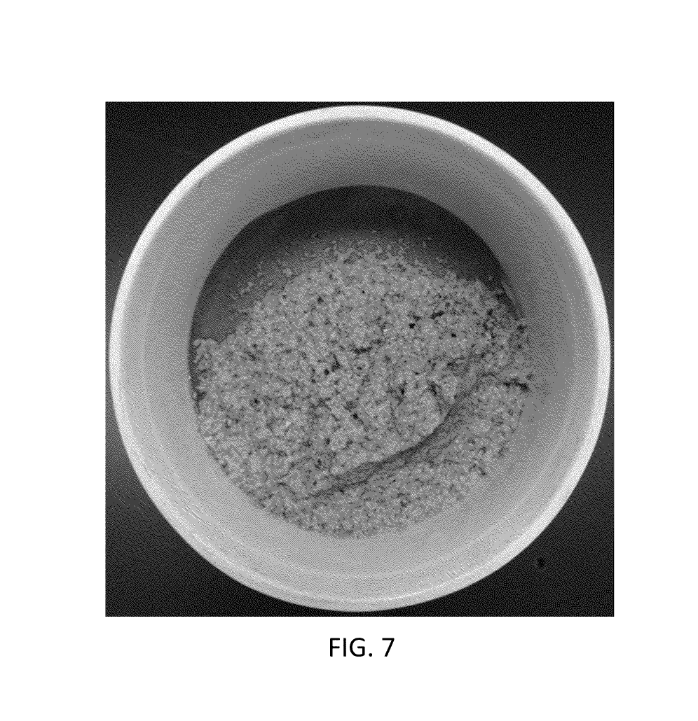

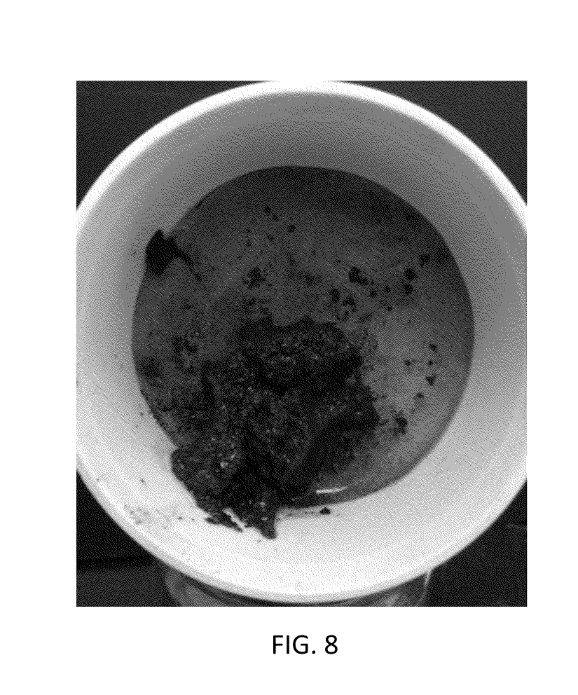

Before each treatment, the tailings sample was agitated with an overhead mixer to re-suspend any fine particles that settled. For samples treated with both activator and tether polymers, an activator polymer was selected to pre-treat the tailings sample, following which the solution was inverted six times. Tether-bearing anchor particles were prepared by adding an amount of the tether polymer solution to a sample of anchor particles and shaking for 10 seconds. For Sample C, an initial amount of tether was added to the tailings prior to activator addition to reduce the turbidity of the supernatant water. The activated fines were poured into the container with the tether-bearing coarse particles and the container was inverted six times. After one minute, the turbidity of the supernatant was measured, and then the solids were analyzed for solids content after gravity filtration on a 70-mesh screen. A representative picture of the solids generated from this standard treatment procedure is shown in FIGS. 6-8 for Samples A, B, and C, respectively. The results are set forth in Table 3 below.

TABLE 3
Results of treatment with activator and tether-bearing anchor particles.

| Tailings | | Dosage | | Dosage* | Turbidity | Solids |
|---|---|---|---|---|---|---|
| Sample | Activator | (ppm) | Tether | (ppm) | (NTU) | (%) |
| A | Flopam AN | 350 | poly(DADMAC) | 100 | 27.4 | 49.9 |
| | 934 VHM | | | | | |
| A | Flopam AN | 450 | poly(DADMAC) | 200 | 23.0 | 52.6 |
| | 934 VHM | | | | | |
| B | Flopam AN | 800 | poly(DADMAC) | 320 | 14.7 | 37.7 |
| | 910 VHM | | | | | |
| C | Flopam AN | 500 | poly(DADMAC) | 100 + 150 | 142 | 57.9 |
| | 910 VHM | | | | | |
| C | Flopam AN | 500 | poly(DADMAC) | 150 + 150 | 144 | 58.6 |
| | 910 VHM | | | | | |

*Dosage is listed as initial tether added to tailings before activator + tether added to anchor particles.

### Example 4

### Tailings Treatment with Thickened Fines

Before each treatment, the tailings sample was agitated with an overhead mixer to re-suspend any fine particles that settled. For samples treated with both activator and tether polymers, an activator polymer was selected to pre-treat the tailings sample, following which the solution was inverted six times. To simulate pumped thickener underflow, the settled, activated fines were: (i) recovered by decanting the water; and then (ii) aggressively shaken in a closed jar 10 times. Tether-bearing anchor particles were prepared by adding an amount of the tether polymer solution to a sample of anchor particles and shaking for 10 seconds. For Sample C, an initial amount of tether was added to the tailings prior to activator addition to reduce the turbidity of the supernatant water. The representative thickener underflow was poured into the container with the tether-bearing coarse particles and the container was inverted six times. After one minute, the turbidity of the supernatant was measured, and then the solids were analyzed for solids content after gravity filtration on a 70-mesh screen. The results are set forth in Table 4 below.

TABLE 4
Results of treatment with activator-treated representative thickener underflow and
tether-bearing anchor particles.

| Tailings | | Dosage | | Dosage* | Turbidity | Solids |
|---|---|---|---|---|---|---|
| Sample | Activator | (ppm) | Tether | (ppm) | (NTU) | (%) |
| A | Flopam AN | 450 | poly(DADMAC) | 200 | >1,000 | 47.5 |
| | 934 VHM | | | | | |
| B | Flopam AN | 800 | poly(DADMAC) | 320 | 312 | 34.5 |
| | 910 VHM | | | | | |
| C | Flopam AN | 500 | poly(DADMAC) | 100 + 150 | >1,000 | 54.6 |
| | 910 VHM | | | | | |

*Dosage is listed as initial tether added to tailings before activator + tether added to anchor particles.

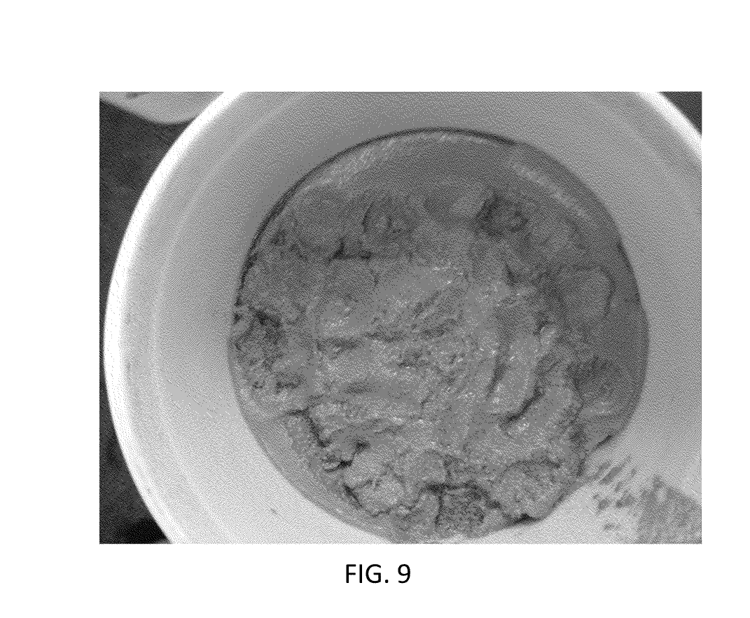

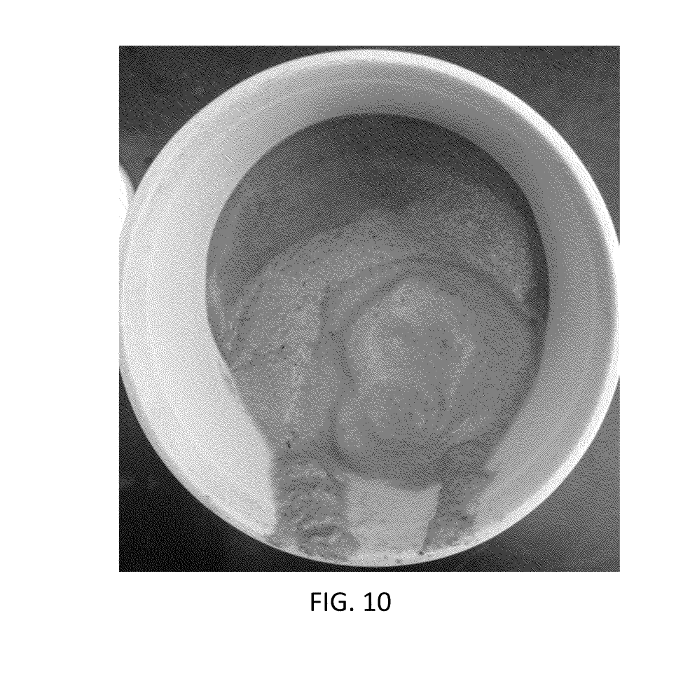

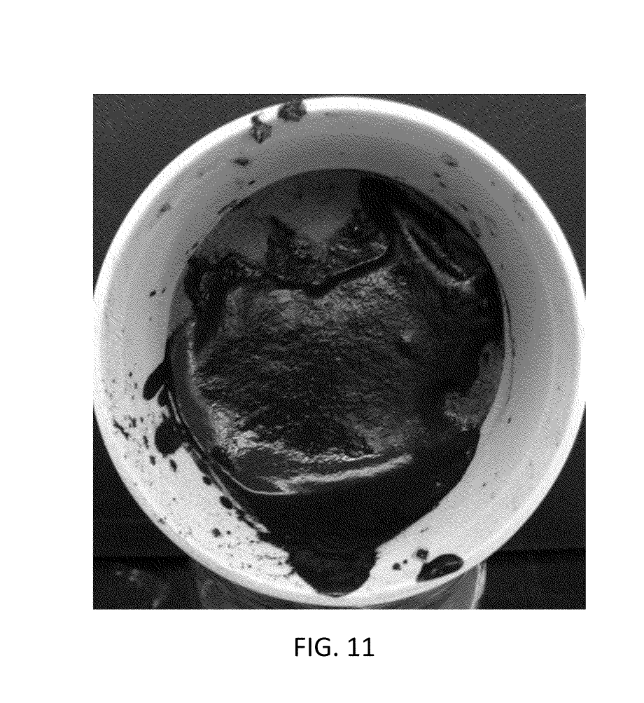

Compared to the standard treatment results, the results obtained with the representative thickener underflow were significantly worse. Namely, turbidity values increased significantly, and the solids had little coherency or mechanical stability, as shown in FIGS. 9-11 for Samples A, B, and C, respectively.

Compared to the standard treatment results, the results obtained with the representative thickener underflow were significantly worse. Namely, turbidity values increased significantly, and the solids had little coherency or mechanical stability, as shown in FIGS. 9-11 for Samples A, B, and C, respectively.

### Example 5

### Tailings Treatment with Thickened and Re-Activated Fines

Before each treatment, the tailings sample was agitated with an overhead mixer to re-suspend any fine particles that settled. For samples treated with both activator and tether polymers, an activator polymer was selected to pre-treat the tailings sample, following which the solution was inverted six times. To simulate pumped thickener underflow, the settled, activated fines were: (i) recovered by decanting the water; and then (ii) aggressively shaken in a closed jar 10 times. This representative thickener underflow was then “re-activated” by adding additional activator as a “re-activator” and shaking for five seconds. Tether-bearing anchor particles were prepared by adding an amount of the tether polymer solution to a sample of anchor particles and shaking for 10 seconds. For Sample C, an initial amount of tether was added to the tailings prior to re-activator addition. The “re-activated” thickener underflow was poured into the container with the tether-bearing coarse particles and the container was inverted six times. After one minute, the turbidity of the supernatant was measured, and then the solids were analyzed for solids content after gravity filtration on a 70-mesh screen. The results are set forth in Table 5 below.

TABLE 5
Results of treatment with re-activated thickener underflow and tether-bearing
anchor particles.

| Tailings | Activator | Dosage* | | Dosage** | Turbidity | Solids |
|---|---|---|---|---|---|---|
| Sample | (“Re-activator”) | (ppm) | Tether | (ppm) | (NTU) | (%) |
| A | Flopam AN 934 | 250 + 100 | poly(DADMAC) | 100 | 40.8 | 54.9 |
| | VHM | | | | | |
| A | Flopam AN 934 | 250 + 200 | poly(DADMAC) | 200 | 63.7 | 55.5 |
| | VHM | | | | | |
| B | Flopam AN 910 | 450 + 350 | poly(DADMAC) | 320 | 10.0 | 39.4 |
| | VHM | | | | | |
| C | Flopam AN 910 | 275 + 225 | poly(DADMAC) | 100 + | 102 | 57.9 |
| | VHM | | | 150 | | |

*Dosage is listed as initial activator amount + re-activation amount.
**Dosage is listed as initial tether added to tailings before activator + tether added to anchor particles.

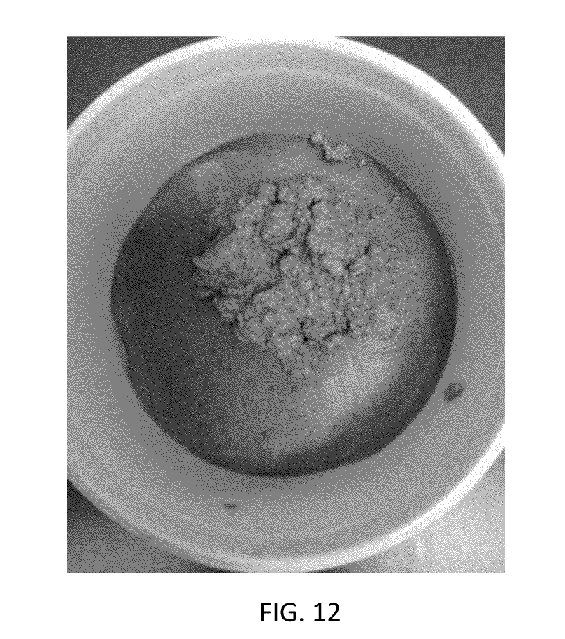

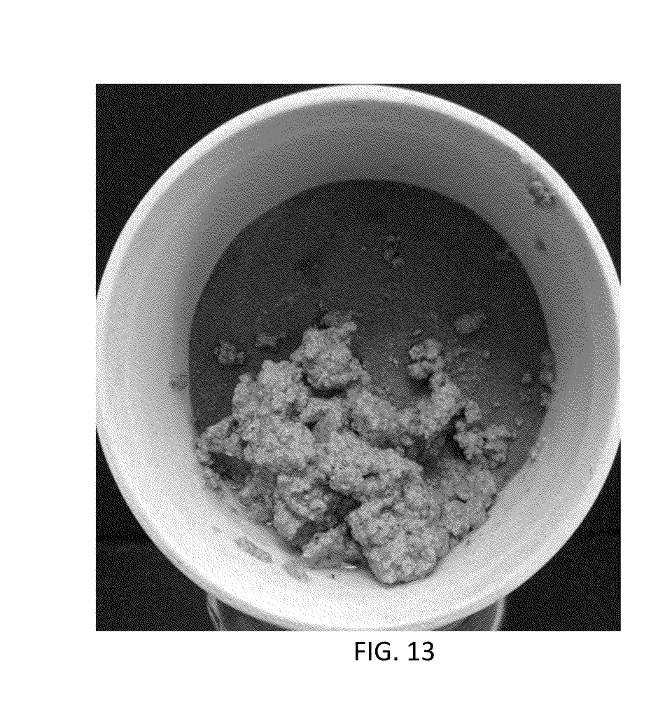

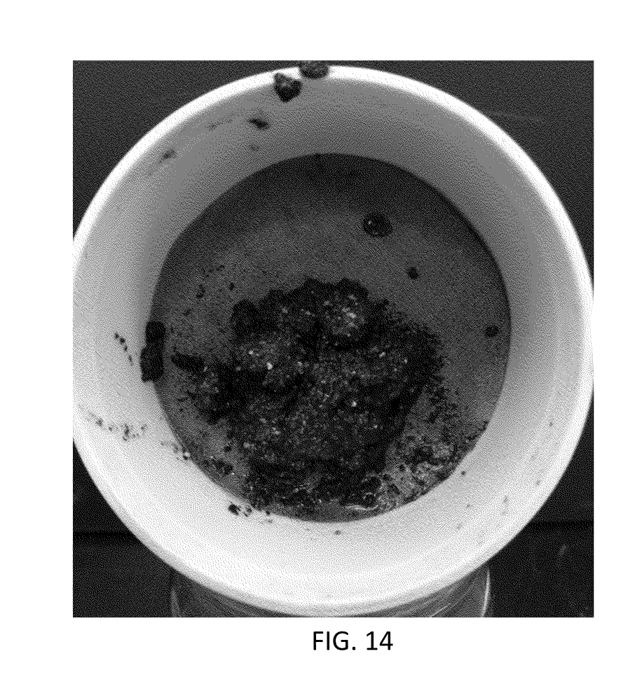

Compared to the standard treatment results, the turbidity values are very comparable, while the solids contents are improved by 4-10% for Samples A and B and remain comparable for Sample C. A representative picture of the solids generated from this re-activation treatment methodology is shown in FIGS. 12-14 for Samples A, B, and C, respectively. Also, the results are clearly improved from the case of the thickened fines with no re-activation, which can be seen by comparison of the recovered solids in FIGS. 9-11 and FIGS. 12-14.

While this invention has been particularly shown and described with references to preferred embodiments thereof, it will be understood by those skilled in the art that various changes in form and details may be made therein without departing from the scope of the invention encompassed by the appended claims.

1. A method of removing particulate matter from a wastewater stream, comprising:
providing an activating agent capable of being affixed to the particulate matter in the wastewater stream;
affixing the activating agent to the particulate matter to form activated particles residing in the wastewater stream;
processing the activated particles in a thickener device to produce a population of thickened flocs in the fluid stream, wherein the thickened flocs comprise the particulate matter;
contacting the thickened flocs with a re-activating agent to form re-activated particles comprising the particulate matter;
providing a population of tether-bearing anchor particles, wherein the tether-bearing anchor particles have an affinity for the re-activated particles;
attaching the tether-bearing anchor particles to the re-activated particles to form removable complexes that comprise the particulate matter; and
removing the removable complexes, thereby removing the particulate matter from the wastewater stream.

2. The method of claim 1, wherein the particulate matter comprises clay fines.

3. The method of claim 1, further comprising treating the particulate matter with a pre-activating agent before or simultaneously with the step of affixing the activating agent to the particulate matter.

4. The method of claim 1, wherein the activating agent is the same as the re-activating agent.

5. The method of claim 1, wherein the population of thickened flocs is removed from the thickener device before the step of contacting it with the re-activating agent.

6. The method of claim 1, wherein the removable complexes are removed by filtration.

7. The method of claim 1, wherein the removable complexes are removed by centrifugation.

8. The method of claim 1, wherein the removable complexes are removed by gravitational settling.

9. The method of claim 1, wherein the tether-bearing anchor particles comprise sand.

10. The method of claim 1, wherein the tether-bearing anchor particles comprise crushed rock.

11. The method of claim 1, wherein the tether-bearing anchor particles comprise sodium chloride.

12. The method of claim 1, wherein the tether-bearing anchor particles comprise a material indigenous to the mining operation.

13. The product obtained or obtainable by the method of claim 1.

14. The method of claim 1, wherein the wastewater stream comprises waste tailing fluid from a mining operation.

15. A system for removing particulate matter from a wastewater fluid from a mining site, comprising:
a conduit that transports the wastewater fluid containing particulate matter from the mining site;
an activating agent affixable to the particulate matter in the wastewater fluid;
a first introducer that directs the activating agent into contact with the particulate matter in the conduit to form activated particles;
a thickener device in fluid communication with the conduit, wherein the thickener device treats the activated particles to form a thickened slurry;
an outlet channel in fluid communication with the thickener device to remove the thickened slurry from the thickener device;
a re-activating agent that interacts with the thickened slurry to form re-activated fines;
a second introducer that directs the re-activating agent into contact with the thickened slurry;
a population of tether-bearing anchor particles capable of attaching to the re-activated fines to form removable complexes in the outlet channel, wherein the removable complexes comprise the particulate matter;
a mixer that directs the tether-bearing anchor particles into contact with the reactivated fines; and
a separator for separating the removable complexes from the outlet channel, thereby removing the particulate matter from the wastewater fluid.
